(19) United States
(12) Patent Application Publication
(10) Pub. No.: US 2022/0161204 A1
(43) Pub. Date: May 26, 2022

(54) DURABLE MEMBRANES, THEIR PREPARATION AND USE

(71) Applicant: Hydroxsys Holdings Limited, Auckland (NZ)

(72) Inventors: Walt WHEELWRIGHT, Auckland (NZ); Dylan Townshend GIFFORD, Hasting (NZ); Sophie Jayne MILLS, Auckland (NZ); Gordon Brett PASCOE, North Hamilton (NZ); Chathuni Duleesha RANAWEERA, Auckland (NZ)

(21) Appl. No.: 17/666,706

(22) Filed: Feb. 8, 2022

Related U.S. Application Data
(63) Continuation-in-part of application No. PCT/IB2020/057503, filed on Aug. 10, 2020.
Application No. PCT/IB2020/057503 is a continuation-in-part of application No. PCT/IB2020/059236, filed on Oct. 2, 2020.

(30) Foreign Application Priority Data
Aug. 9, 2019 (AU) 2019902876
Oct. 2, 2019 (AU) 2019903701
Oct. 2, 2019 (AU) 2019903703
Apr. 1, 2020 (AU) 2020901007
Aug. 10, 2020 (AU) 2020902821

(51) Int. Cl. B01D 71/26; B01D 67/00; B01D 63/10

(52) U.S. Cl. CPC B01D 71/26; B01D 2323/38; B01D 63/10; B01D 67/0006

(57) ABSTRACT

Filtration membranes comprising a microporous sheet of polyolefin grafted with a poloxamer are described. In an embodiment, the poloxamer is that supplied under the trade name PLURONIC™ P-123 and the polyolefin is poly(ethylene). The membranes provide the advantage of being tolerant to the cleaning agents used in clean-in-place protocols and can be used to remove particulates from these aqueous feed streams.

### TECHNICAL FIELD

The invention relates to durable filtration membranes, filter membrane assemblies comprising such membranes, and their use in recovering water from feed streams. In particular, the invention relates to durable filtration membranes and their use in recovering water from feed streams where periodic in situ cleaning of the membrane is required.

### BACKGROUND ART

It is well-known to use grafting to modify the surface of films, sheets and moulded objects formed from polyolefins. For example, the publication of Tazuke and Kimura (1978) discloses photografting onto poly(propylene), poly(ethylene) and several other polymer films using benzophenone as a sensitizer. In this publication the choice of solvent and sensitizer was noted to be very important.

The publication of Ang et al (1980) discloses an irradiation procedure where the sensitizer is dissolved in the monomer solution and can be used for the photosensitized copolymerization in high yields of styrene, 4-vinyl pyridine and methyl methacrylate to poly(propylene). Again, this publication notes that the reaction was found to be very specific to certain types of sensitizers.

The publication of Ogiwara et al (1981) discloses the photografting on poly(propylene) and low-density poly(ethylene) (LDPE) films on which sensitizers were coated beforehand. The sensitizers coated on films enabled vinyl monomers, such as methyl methacrylate, acrylic acid and methacrylic acid to graft easily with high yields. The hydrophilic monomers acrylic acid and methacrylic acid were conveniently grafted using them in aqueous solution in a liquid phase system.

The publication of Allmer et al (1983) discloses the modification of surfaces of LDPE, high-density poly(ethylene) (HDPE) and polystyrene by grafting with acrylic acid. The grafting is performed in the vapor-phase and increased the wettability of the polymer. It was observed that acetone was able to initiate grafting and was found to promote and direct grafting to the surface. The later publication of Allmer et al (1969) discloses the grafting of the surface of LOPE with glycidyl acrylate and glycidyl methacrylate by photoinitiation. Acetone and ethanol were used as solvents, with acetone yielding slightly more grafting at the surface.

The publications of Yao and Ranby (1990a, 1990b and 1990c) disclose inter alia a process for the continuous photoinitiated graft copolymerization of acrylamide and acrylic acid onto the surface of HDPE tape film. The process is performed under a nitrogen atmosphere using benzophenone as the photoinitiator. It was noted that pre-soaking was very important for efficient photographing within short irradiation times. The application of this pre-soaking photografting method to poly(ethylene terephthalate) (PET) was also disclosed. In this context acetone was found to be a somewhat better solvent than methylethylketone and methylpropylketone. When applied to a continuous process for the photochemically induced graft polymerization of acrylamide and acrylic acid of poly(propylene) (PP) fibre surface under a nitrogen atmosphere, optimal concentrations of monomer and initiator in the pre-soaking solution were determined.

The publications of Kubota and Hata (1990a and 1990b) disclose an investigation of the location of methacrylic acid chains introduced into poly(ethylene) film by liquid and vapor-phase photografting and a comparative examination of the photografting behaviours of benzil, benzophenone and benzoin ethyl ether as sensitizers. In these latter studies poly(methacrylic acid) was grafted onto initiator-coated LDPE film.

The publication of Edge et al (1993) discloses the photochemical grafting of 2-hydroxyethyl methacrylate (HEMA) onto LDPE film. A solution phase method is used to produce a material with increased wettability.

The publication of Singleton et al (1993) discloses a method of making a polymeric sheet wettable by aqueous solvents and useful as an electrode separator in an electrochemical device. The polymeric sheet is formed from fibres which comprise poly(propylene) alone and is distinguished from a membrane formed from a microporous polymer sheet.

The publication of Zhang and Ranby (1993) discloses the photochemically induced graft copolymerisation of acrylamide onto the surface of PP film. Acetone was shown to be the best solvent among the three aliphatic ketones tested.

The publications of Yang and Ranby (1996a and 1996b) disclose factors affecting the photografting process, including the role of far UV radiation (200 to 300 nm). In these studies benzophenone was used as the photoinitiator and LDPE film as the substrate. Added water was shown to favour the photografting polymerisation of acrylic acid on the surface of polyolefins, but acetone was shown to have a negative effect due to the different solvation of poly(acrylic acid) (PAA).

The publication of Hirooka and Kawazu (1997) discloses alkaline separators prepared from unsaturated carboxylic acid grafted poly(ethylene)-poly(propylene) fibre sheets. Again, the sheets used as a substrate in these studies are distinguished from a membrane formed from a microporous polymer sheet.

The publication of Xu and Yang (2000) discloses a study on the mechanism of vapor-phase photografting of acrylic acid onto LDPE.

The publication of Shentu et al (2002) discloses a study of the factors, including the concentration of monomer, affecting photo-grafting on LDPE.

The publication of El Kholdi et al (2004) discloses a continuous process for the graft polymerisation of acrylic acid from monomer solutions in water onto LDPE.

The publication of Bai et al (2011) discloses the preparation of a hot melt adhesive of grafted low-density poly(ethylene) (LDPE). The adhesive is prepared by surface UV photografting of acrylic acid onto the LDPE with benzophenone as the photoinitiator.

The publication of Choi et al (2001) states that graft polymerisation is considered as a general method for modifying the chemical and physical properties of polymer materials.

The publication of Choi (2002) discloses a method for producing an acrylic graft polymer on the surface of a polyolefin article comprising the steps of immersing the article in a solution of an initiator in a volatile solvent, allowing the solvent to evaporate, and then immersing the article in a solution of an acrylic monomer before subjecting the article to ultraviolet irradiation in air or an inert atmosphere. Acrylic acid is used as the acrylic monomer in each one of the Examples disclosed in the publication, although the use of equivalent amounts of methacrylic acid, acrylamide and other acrylic monomers is anticipated.

The publication of Choi (2004) discloses the use of “ethylenically unsaturated monomers” in graft polymerisation. These other monomers are disclosed as monomers that are polymerizable by addition polymerisation to a thermoplastic polymer and are hydrophilic as a consequence of containing carboxyl (—COCH), hydroxyl (—OH), sulfonyl (So₂), sulfonic acid (—SO₃H) or carbonyl (—CO) groups. No experimental results concerning the chemical and physical properties of graft polymers prepared by a method using these other monomers is disclosed.

The publication of Choi (2005) discloses a non-woven sheet of polyolefin fibres where opposed surfaces of the sheet are hydrophilic as a consequence of an acrylic graft polymerisation. The properties of the sheet are asymmetric, the ion exchange coefficient of the two surfaces being different. The method used to prepare these asymmetric acrylic craft polymerised non-woven polyolefin sheets comprises the steps of immersing the substrates in a solution of benzophenone (a photoinitiator), drying and then immersing the substrate in a solution of acrylic acid prior to subjecting to ultraviolet (UV) irradiation. The irradiation may be performed when the surfaces are in contact with either air or an inert atmosphere.

The publication of Gao et al (2013) discloses a method of preparing a radiation cross-linked lithium-ion battery separator. In an example, a porous polyethylene membrane is immersed in a solution of benzophenone and triallyl cyanurate in dichloromethane. The immersed membrane is dried at room temperature before being immersed in a water bath at 30° C. and irradiated on both sides using a high-pressure mercury lamp for three minutes.

The publication of Jaber and Gjoka (2016) discloses the grafting of ultra-high molecular weight polyethylene microporous membranes using monomers having one or more anionic, cationic or neutral groups. The publication states that the authors have discovered that molecules can be grafted on the surface of an asymmetric, porous ultra-high molecular weight polyethylene membrane using an ultraviolet radiation energy source. The grafted membranes are proposed for use in removing charged contaminants from liquids.

The objective of the majority of these prior art methods is to improve the adhesion, biocompatibility, printability or wettability of the surface of a substrate using photoinitiated polymerisation. These methods are to be distinguished from the use of UV-initiated grafting with an exogenously prepared preformed polymer to modify the permeability to water of a hydrophobic microporous polyolefin substrate.

The publication of Schmolka (1973) discloses the preparation of polyoxyethylene-polyoxypropylene block polymers represented by the formula:

$$HO ( {C}_{2} {H}_{4} O ) \text{?} ( C \text{?} H \text{?} O ) \text{?} ( {C}_{2} {H}_{4} O ) \text{?} H$$

$$\text{?} \text{indicates text missing or illegible when filed}$$

where a is an integer such that the hydrophobic base represented by (C₃H₂O) has a molecular weight of at least 2,250 and b is an integer from about 8 to 180 or higher. These block polymers are used to prepare solid or semisolid colloids containing considerable quantities of liquid—‘gels’ or ‘hydrosols’ (where the liquid is water) that are particularly useful in the formulation of topically applied cosmetic and pharmaceutical compositions. Referred to as poloxamers, these nonionic triblock copolymers are supplied under a number of trade names, including ACCLAIM™, ADEKANOL™, ANTAROX™, BASORCL™, BLAUNON™, ETHOX™, KOLLIPHOR™, LUTROL™, MEROXAPOL™, PLURIOL™, PLURONIC™ and SYNPERONIC™. The properties of the poloxamer are determined by both the ratio and size of the integers a and b. Triblock copolymers in which the order of the polyoxyethylene and polyoxypropylene blocks is reversed are also supplied under these trade names. These “reverse” triblock copolymers may be identified by the use of the letter “P” and should not be referred to as “poloxamers”.

The publication of Wang et al (2006) discloses the formation of membranes from blends of polyether sulfone and different triblock copolymers by a phase inversion method. Water fluxes determined for the membranes were observed to be dependent on the triblock copolymer structure rather than content. For example, the water flux (50.161 LMH) of a membrane formed from a blend with PLURONIC™ 123 was observed to be less than that. (104.081 LMH) observed for the polyether sultone control membrane. The water flux (218.28 LMH) of a membrane formed from a blend with PLURONIC™ P68 was observed to be higher than that of the control membrane.

The publication (machine translation) of Liu et al (2014) discloses the preparation of a microporous membrane with a microstructured surface for use in the separation of oil from water in oil/water emulsions. In the method of preparing the membrane polyoxyethylene-polyoxypropylene-polyoxyethylene (P127) is used as an additive in the preparation of a homogenous solution of polymer in solvent. The polymer is selected from a group consisting of polyvinylidene fluoride (PV-DF), polysulfone (PSf), polyether sulfone (PES), polyacrylonitrile (PAN), polyvinyl chloride (PVC), polylactic acid (PLA), polyimide (PI), polypropylene (PP) or cellulose acetate and the solvent is selected from a group consisting of chloroform (CHCl₃), N,N-dimethyl formamide (DMF), N,N-dimethyl acetamide (DMAc), phosphoric acid triethyl ester (TEP), trimethyl phosphate (TMP), N-methyl pyrrolidone (NMP), dimethyl solfoxide (DMSO), tetrahydrofuran (THF), dibutyl phthalate (DBP), dioxane, propiophenone, diphenyl ether in one or more mixtures thereof.

The publication of Yang et al (2014) discloses a composite polymer electrolyte for use in lithium-polymer batteries. The composite was composed of mesoporous modified silica fillers dispersed in poly(vinylidene fluoride-hexafluoropropylene) matrix. The triblock copolymer PLURONIC™ 123 (Aldrich) was used in the preparation of the mesoporous silica fillers.

The publication of Guo et al (2015) discloses a microporous material used in micro- and ultrafiltration membranes. The microporous material comprises finely divided particles, such as water insoluble silica filler, distributed throughout a matrix, such as poly(ethylene). The material further comprises a network of interconnecting pores and may be further processed depending on the desired application. In such further processing triblock copolymers based on poly(ethylene oxide)-poly(propylene oxide)-poly(ethylene oxide) may be used as a hydrophilic coating, although polymers comprising tertiary amine functional groups are preferred. Without intending to be bound by theory, it is stated that components of the coating may interact with the silica particles in the fill of the microporous material and adjust the surface energy, affecting wettability. No covalent binding of the hydrophilic coating, such as that achievable by grafting, is disclosed.

The publication (machine translation) of Cheng et al (2017) discloses the use of poly(ethylene oxide)-poly(propylene oxide)-poly(ethylene oxide) triblock copolymer as a “structure directing agent” in the preparation of a mesoporous composite film. The structure directing agent is used with a catalyst and precursor compound such as tetraethyl orthosilicate, titanium tetrachloride, titanium n-butyl acetate, isopropyl titanium, phthalic acid di-zinc acetate, tin ester and one or more of niobate to provide the mesoporous composite film.

The publication of Carter et al (2018) discloses the evaluation of the triblock copolymer PLURONIC™ L64 as a solvent for pore filling regenerated cellulose membranes during initiator immobilisation. Glycerol was determined to be a more efficient pore filling solvent in this context.

The majority of these prior art methods are using the triblock copolymer as an aid in the preparation of membranes as opposed to an integral component.

The publication of Bolto et al (2009) reviews what is disclosed in publications concerning the cross-linking of poly(ethenol), i.e. PVA. These publications include those concerning cross-linking methods and the grafting of PVA onto support membranes, including porous hydrophobic membranes such as poly(ethylene) and poly(propylene).

The publication of Linder et al (1988) discloses semipermeable composite membranes comprising a film of modified PVA or PVA-copolymers on a porous support. Suitable support materials are required to be water insoluble and may be chosen, e.g. from polyacrylonitriles, polysulfones, polyamides, polyolefins such as poly(ethylenes) and poly(propylenes), or cellulosics.

The publication of Exley (2016) discloses an asymmetric composite membrane consisting of a film of cross-linked poly(ether ether ketone) adhered to a sheet of grafted microporous poly(ethylene). The microporous poly(ethylene) is obtained by photoinitiated grafting with an ethenyl monomer to provide a hydrophilic sheet.

The publication of Craft et al (2017) discloses improvements in the asymmetric composite membranes disclosed in the publication of Exley (2016). The improved asymmetric composite membranes comprise of poly(vinyl alcohol) polymer crosslinked with a crosslinking agent (such as divinyl benzene) coated on a film of cross-linked poly(ether ether ketone) adhered to a sheet of the grafted microporous poly(ethylene). The improvement is in the selectivity of the asymmetric composite membrane obtained.

The plant used in beverage and food processing is required to be periodically cleaned. Cleaning may be required because of fouling by non-specific adsorption or deposition of proteins, or to avoid microbial contamination of the processed beverage or food. Efficiencies in plant operation are realised if the filtration membranes can be cleaned in situ. The aqueous cleaning solutions used in these cleaning procedures are chemically aggressive (acid, caustic, hypochlorite, peroxide, etc.). After use, the spent solution, often containing particulates from the cleaning operation, is required to be disposed of incurring cost and potential harm to the environment.

The ability to recover and reuse the aqueous cleaning solutions without compromise to the efficacy of the cleaning operations would be advantageous but presents a number of challenges. Any filtration membrane used to separate particulates from the aqueous solutions must be durable, i.e. able to tolerate all the chemically aggressive cleaning solutions. Secondly, the filtration membrane must be capable of being used in a compact configuration, e.g. a spiral-wound filter element, and provide a flux sufficiently high for reuse of the cleaning solutions to be practical in a commercial setting.

It is an object of the present invention to provide filtration membranes suitable for use in these and other circumstances or at least to provide a useful choice in the selection of filtration membranes for use in these and other circumstances.

### STATEMENT OF INVENTION

In a first aspect a water-wettable filtration membrane comprising a poloxamer adhered to a substrate consisting of a microporous sheet of polyolefin is provided. The poloxamer is adhered to a preformed microporous sheet of the polyolefin. The poloxamer is adhered to the polyolefin matrix of the preformed microporous sheet by the formation of covalent bonds between the two polymers.

The covalent bonds may be formed directly between the poloxamer and the polyolefin or indirectly via a crosslinking agent.

Preferably, the poloxamer is adhered to the matrix by grafting. Most preferably, the poloxamer is adhered to the matrix by photoinitiated grafting. In this context, the photoinitiated grafting will be understood to encompass the formation of covalent bonds initiated by irradiation with ultraviolet (UV) light, preferably UVC light, in the presence of a suitable photoinitiator. Suitable photoinitiators are type II photoinitiators such as benzophenone (diphenylmethanone; BP). The photoinitiated grafting is advantageously performed in the presence of a crosslinking agent. Suitable cross-linking agents are low molecular weight diethenyl compounds. Low molecular weight diethenyl compounds are those with a molecular weight below 150 g mol⁻¹, such as divinylbenzene (DVB).

Preferably, the poloxamer is a polymer of the structure

$$HO ( ethylene oxide ) \text{?} - ( propylene oxide ) \text{?} - ( ethylene oxide ) \text{?} H$$

$$\text{?} \text{indicates text missing or illegible when filed}$$

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the polyolefin is poly(ethylene) or poly(propylene). More preferably, the polyolefin is poly(ethylene). Most preferably, the polyolefin is a virgin poly(ethylene).

In a first embodiment of the first aspect a water-wettable filtration membrane consisting of a microporous sheet of grafted poly(ethylene) is provided where the graft comprises a poloxamer of the structure:

$$HO ( ethylene oxide ) \text{?} - ( propylene oxide ) \text{?} - ( ethylene oxide ) \text{?} H$$

$$\text{?} \text{indicates text missing or illegible when filed}$$

where m is in the range 15 to 25 and n is in the range 50 to 90.

In a second embodiment of the first aspect a water-wettable filtration membrane consisting of a microporous sheet of grafted poly(ethylene) is provided where the graft comprises divinylbenzene and a poloxamer of the structure:

$$HO ( ethylene oxide ) \text{?} - ( propylene oxide ) \text{?} - ( ethylene oxide ) \text{?} H$$

$$\text{?} \text{indicates text missing or illegible when filed}$$

where m is in the range 15 to 25 and n is in the range 50 to 90.

In a second aspect a water-wettable filtration membrane comprising a microporous sheet of grafted polyolefin is provided where the polyolefin is grafted with a blend of preformed polymers comprising a poloxamer of the structure:

$$HO ( ethylene oxide ) \text{?} - ( propylene oxide ) \text{?} - ( ethylene oxide ) \text{?} H$$

$$\text{?} \text{indicates text missing or illegible when filed}$$

where m is in the range 15 to 25 and n is in the range 50 to 90.

Preferably, the blend of preformed polymers comprises the poloxamer and poly(4-ethenyl benzene sulfonic acid).

Preferably, the blend of preformed polymers is adhered to the matrix by grafting. Most preferably, the blend of preformed polymers is adhered to the matrix by photoinitiated grafting. In this context, the photoinitiated grafting will be understood to encompass the formation of covalent bonds initiated by irradiation with ultraviolet (WV) light, preferably UVC light, in the presence of a suitable photoinitiator. Suitable photoinitiators are type II photoinitiators such as benzophenone (diphenylmethanone; BP). The photoinitiated grafting is advantageously performed in the presence of a crosslinking agent. Suitable crosslinking agents are low molecular weight diethenyl compounds. Low molecular weight diethenyl compounds are those with a molecular weight below 150 g mol³, such as divinylbenzene (DVB).

Preferably, the blend of preformed polymers comprises a poloxamer of the structure

$$HO ( ethylene oxide ) \text{?} - ( propylene oxide ) \text{?} - ( ethyl ene oxide ) \text{?} H$$

$$\text{?} \text{indicates text missing or illegible when filed}$$

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the polyolefin is poly(ethylene) or poly(propylene). More preferably, the polyolefin is poly(ethylene). Most preferably, the polyolefin is a virgin poly(ethylene).

In a first embodiment of the second aspect a water-wettable filtration membrane consisting of a microporous sheet of grafted poly(ethylene) is provided where the graft consists of a blend of preformed polymers comprising a poloxamer of the structure:

$$HO ( ethylene oxide ) \text{?} - ( propylene oxide ) \text{?} - ( ethyl ene oxide ) \text{?} H$$

$$\text{?} \text{indicates text missing or illegible when filed}$$

where m is in the range 15 to 25 and n is in the range 50 to 90.

In a second embodiment of the second aspect a water-wettable filtration membrane consisting of a microporous sheet of grafted poly(ethylene) is provided where the graft consists of divinylbenzene and a blend of preformed polymers comprising a poloxamer of the structure:

$$HO ( ethylene oxide ) \text{?} - ( propylene oxide ) \text{?} - ( ethyl ene oxide ) \text{?} H$$

$$\text{?} \text{indicates text missing or illegible when filed}$$

where m is in the range 15 to 25 and n is in the range 50 to 90.

It is anticipated that poly(propylene) may be substituted for poly(ethylene) in either of the first or second embodiments of the first or second aspects.

Preferably, the filtration membrane of the first or second aspects is capable of separating micro-dimensioned particulates from an aqueous carrier. The micro-dimensioned particulates may be of abiotic or biotic origin, including bacterial cells. More preferably, the membranes of the first or second aspects provide for a flux of the aqueous carrier of greater than 25 LMH at a pressure of 5 bar. Most preferably, the aqueous carrier is a used cleaning solution.

Preferably, the filtration membranes of the first or second aspects are semipermeable membranes.

In a third aspect a composite membrane comprising a film of at least partially crosslinked poly(ethenol) adhered to a hydrophilicitized microporous sheet of polyolefin is provided. Preferably, the polyolefin of the hydrophilicitized microporous sheet has been grafted with a preformed poly(4-ethenyl benzene sulfonic acid) or a poloxamer or a blend thereof before adherence of the film of poly(ethenol). More preferably, the polyolefin of the hydrophilicitized microporous sheet has been grafted with a poloxamer or a blend thereof before adherence of the film of poly(ethenol). Yet more preferably, the polyolefin of the hydrophilicitized microporous sheet has been grafted with a poloxamer of the structure:

$$HO ( ethylene oxide ) \text{?} - ( propylene oxide ) \text{?} - ( ethyl ene oxide ) \text{?} H$$

$$\text{?} \text{indicates text missing or illegible when filed}$$

where m is in the range 15 to 25 and n is in the range 50 to 90. Most preferably, the poloxamer is equivalent to the polymer sold under the trade name PLURONIC™ P-123 (Sigma-Aldrich).

Preferably, the polyolefin is selected from the group consisting of: poly(ethylene), poly(propylene), poly(butylene) and poly(methylpentene). More preferably, the polyolefin is poly(ethylene) or poly(propylene). Most preferably, the polyolefin is poly(ethylene).

In a first embodiment of the third aspect, a composite membrane consisting essentially of a film of at least partially crosslinked poly(ethenol) adhered to a microporous sheet of polyolefin grafted with a poloxamer is provided.

In a second embodiment of the third aspect, a composite membrane consisting essentially of a film of at least partially crosslinked poly(ethenol) adhered to a microporous sheet of poly(ethylene) grafted with a poloxamer equivalent to the polymer sold under the trade name PLURONIC™ P-123 (Sigma-Aldrich) is provided.

Preferably, the composite membrane is an asymmetric composite membrane.

In a fourth aspect a method of preparing a water-wettable filtration membrane is provided, where the method comprises:
1. Contacting a microporous sheet of polyolefin with a solution in a solvent comprising a poloxamer to provide a contacted sheet;
2. Irradiating the contacted sheet with ultraviolet light in the presence of a photoinitiator to provide an irradiated sheet; and then
3. Washing and drying the irradiated sheet to provide the membrane.

Preferably, the polyolefin is poly(ethylene) or poly(propylene). More preferably, the polyolefin is poly(ethylene). Most preferably, the polyolefin is virgin poly(ethylene).

Preferably, the solution comprises the photoinitiator. More preferably, the solution additionally comprises a crosslinking agent.

Preferably, the poloxamer is a polymer of the structure

$$HO ( ethylene oxide ) \text{?} - ( propylene oxide ) \text{?} - ( ethyl ene oxide ) \text{?} H$$

$$\text{?} \text{indicates text missing or illegible when filed}$$

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the solvent is water-alcohol or water-acetone where the ratio (v/v) of water to the alcohol or acetone is in the range 1:1 to 3:1. More preferably, the ratio (v/v) of water to the alcohol or acetone is in the range 1:1 to 2:1. Most preferably, the solvent is water-ethanol.

Preferably, the photoinitiator is a Type II photoinitiator. Most preferably, the photoinitiator is benzophenone (diphenylmethanone; BP).

Preferably, the crosslinking agent is a diethenyl compound with a molecular weight below 150 g mol⁻¹. Most preferably, the crosslinking agent is divinylbenzene (DVB).

Preferably, the ultraviolet light is UVC light. Preferably, the wavelength of the ultraviolet light is centred in the range 250 to a3 nm. More preferably, the wavelength of the ultraviolet light is centred in the range 250 to 280 nm. Most preferably, the wavelength of the ultraviolet light is centred at 250 nm.

Preferably, the irradiating is for a period of time between one and a half minutes and two and a half minutes. More preferably, the irradiating is for a period of time of two minutes plus or minus 10 seconds.

In an embodiment of the fourth aspect a method of preparing a water wettable membrane is provided, the method comprising irradiating at a wavelength centred at 250 nm a microporous sheet of poly(ethylene) impregnated with a solution in 30 to 50% (v/v) ethanol in water of 3 to 5% (w/v) of the poloxamer supplied as PLURONIC™ P-123, 0.5 to 1% (w/v) benzophenone, and 0 to 0.5% (w/v) divinylbenzene.

It is anticipated that poly(propylene) may be substituted for poly(ethylene) in this embodiment of the fourth aspect.

In a fifth aspect a method of preparing a composite membrane is provided, the method comprising the steps of:
1. Contacting in the presence of a radical initiator:
   a solution in a first solvent of poly(ethenol), and
   a hydrophilicitized microporous sheet of the first or second aspects, to provide a contacted sheet;
2. Irradiating the contacted sheet with ultraviolet light to provide an irradiated sheet;
3. Drying the irradiated sheet to provide a dried sheet; and then
4. Washing the dried sheet in a second solvent to provide the composite membrane.

Preferably, the hydrophilicitized microporous sheet of the first or second aspect will be a hydrophilicitized microporous sheet of polyolefin where the polyolefin has been grafted with a poloxamer or a blend of preformed polymers comprising a poloxamer.

Preferably, the first solvent is water-alcohol or water.

Preferably, the second solvent is water.

Preferably, the drying of the contacted sheet will be by applying a positive thermal gradient across the thickness of the sheet from the contacted one side of the hydrophilicitized microporous sheet to the other side.

Preferably, the composite membrane is an asymmetric composite membrane.

In a sixth aspect a method of removing particulates from an aqueous feed stream is provided, the method comprising contacting a first side of a filtration membrane of the first or second aspects with the feed stream at a pressure sufficient to provide a permeate.

Preferably, the feed stream is selected from the group consisting of cleaning solutions and waste water. More preferably, the feed stream is selected from the group consisting of: caustic cleaning solution, citric acid cleaning solution and hypochlorite cleaning solution.

The particulates may be micro-dimensioned. The particulates may be of abiotic or biotic origin, including bacterial cells. Preferably, the pressure is less than 10 bar. Preferably, the filtration membrane is in the form of a spiral wound filtration membrane assembly or filter element.

In a seventh aspect the invention provides a spiral wound filtration membrane assembly or filter element comprising a membrane of the first, second or third aspects.

In the description and claims of this specification the following abbreviations, acronyms, phrases and terms have the meaning provided: “block” means portion of a macromolecule comprising many constitutional units, that has at least one constitutional or configurational feature which is not present in the adjacent portions; “CAS RN” means Chemical Abstracts Service (CAS, Columbus, Ohio) Registry Number; “comprising” means “including”, “containing” or “characterized by” and does not exclude any additional element, ingredient or step; “consisting essentially of” means excluding any element, ingredient or step that is a material limitation; “consisting of” means excluding any element, ingredient or step not specified except for impurities and other incidentals; “crosslinking” means a reaction involving sites or groups on existing macromolecules or an interaction between existing macromolecules that results in the formation of a small region, such as a crosslinking bridge, in a macromolecule from which at least four chains emanate; “crosslinking agent” means a material that is incorporated into the crosslinking bridge of a crosslinked polymer network; “curing” means chemical process of converting a prepolymer or a polymer into a polymer of higher molecular mass and connectivity and finally into a network; “filter” means to remove particles from a fluid by passing through a porous substrate and “filtration” has a corresponding meaning; “flux” means the rate (volume per unit of time) of permeate transported per unit of membrane area; “graft polymer” means a polymer in which the linear main chain has attached to it at various points side chains of a structure different from the main chain; “grafting” means a reaction in which one or more species of block are connected to the main chain of a macromolecule by side chains having constitutional configurational features that differ from those in the main chain and “grafted” has a corresponding meaning; “homopolymer” means a polymer formed by the polymerization of a single monomer; “hydrophilic” means having a tendency to mix with, dissolve in, or be wetted by water and “hydrophilicity”, “hydrophilicitized” and “hydrophilicitizing” have a corresponding meaning; “LMH” means litres per hour per square metre; “impregnating” means permeating a substrate, e.g. with a solution of reagents in a solvent; “macromolecule” or “polymer” means a molecule of high relative molecular mass, the structure of which essentially comprises the multiple repetition of units derived, actually or conceptually, from molecules of low relative molecular mass; “microporous” means consisting of an essentially continuous matrix structure containing substantially uniform small pores or channels throughout the body of the substrate (such as may be manufactured using a cast (wet) process technology) and specifically excludes a discontinuous matrix of woven or non-woven fibres; “micro-dimensioned” means having a dimension as low as 0.5 micron; “monomer molecule” means a molecule which can undergo polymerisation, thereby contributing constitutional units to the essential structure of a macromolecule; “monomeric unit”, “monomer unit” or “mer” means the largest constitutional unit contributed by a single monomer molecule to the structure of a macromolecule; “partially crosslinked” means that only a portion of the available sites for cross-linking are utilised and the cross-linking reaction has been limited by reagents, temperature or period of time; “permeable” means allowing the passage of a solvent, e.g. water; “permeate” means to spread throughout; “photoinitiator” means a photolabile compound which upon irradiation forms a radical; “poloxamer” means a symmetrical non-ionic triblock copolymer composed of a central chain of poly(propylene oxide) flanked by two chains of poly(ethylene oxide); “poly(ethenol)” and “polyvinyl alcohol” are used synonymously; “post-treated polymer” means a polymer that is modified, either partially or completely, after the basic polymer backbone has been formed; “preformed” means formed beforehand, i.e. prior to treatment; “PSSS” or “pSSS” denotes the product of the polymerization of SSS, i.e. poly(4-ethenylbenzenesulfonic acid); “PVA” denotes poly(ethenol) (or polyvinyl alcohol); “semipermeable” means allowing certain substances to pass through, but not others, especially allowing the passage of a solvent, e.g. water, but not of certain solutes, e.g. proteins, salts or sugars; “SSS” denotes sodium styrene sulfonate, i.e. the sodium salt of 4-ethenylbenzenesulfonic acid; “UVA” means electromagnetic radiation having wavelengths between 320 and 400 nm; “UVB” means electromagnetic radiation having wavelengths between 290 and 320 nm; “UVC” means electromagnetic radiation having wavelengths between 200 and 290 nm; “water-wettable” means wettable with water; “wettable” means becoming permeated with solvent, e.g. water, on being contacted with the solvent under standard laboratory conditions (i.e. 25° C. at 100 kPa), and “xPVA” denotes PVA that is at least partially crosslinked.

A patronym of any of the defined terms has a corresponding meaning. Where there is uncertainty in respect of the meaning of an undefined abbreviation, acronym, phrase or term relating to polymer terminology and nomenclature the meaning provided in the publication of Jones et al (2008) is to take precedent. The terms “first”, “second”, “third”, etc. used with reference to elements, features or integers of the subject matter defined in the Statement of Invention and Claims, or when used with reference to alternative embodiments of the invention are not intended to imply an order of preference. The lettering or numbering of the Examples and Comparative Examples (if any) is not intended to mean any pair of Example and Comparative Example is directly comparable. Where values are expressed to one or more decimal places standard rounding applies. For example, 1.7 encompasses the range 1.650 recurring to 1.749 recurring. Where concentrations or ratios of reagents or solvents are specified, the concentration or ratio specified is the initial concentration or ratio of the reagents or solvents. Similarly, where a pH or pH range is specified the pH or range specified is the initial pH or pH range. References to the use of 4-ethenylbenzenesulfonic acid encompass references to the use of salts of the acid, including SSS. It is recognised that the porosity determined for a substrate will depend at least in part or the method employed to determine the porosity. In the present description the term “microporous” is being used to refer to the porosity of a sheet of polyolefin that is equivalent to the porosity of TARGRAY™ wet process polyethylene separators, item no. SW320H (Targray, Kirkland QC, Canada). In this context the term “equivalent” means the porosity determined for the sheet of polyolefin is 75 to 125% of the porosity determined for TARGRAY™ wet process polyethylene separators, item no. SW320H (Targray, Kirkland QC, Canada) by the same method.

The invention will now be described with reference to embodiments or examples and the figures of the accompanying drawings pages. In the Brief Description of Drawings and elsewhere in the following description, reference to the “top” (Crop, Etop, etc.) of a membrane refers to the face or side of the membrane or sheet with which the working solution is contacted. Reference to the “back” (etc.) or “backing layer” refers to the opposite face or side. It will be understood that due to the mounting of the membrane or sheet in the filtration membrane assembly the entire face or side is not exposed to the feed stream. A description of this filtration membrane assembly (Sterlitech Corp.) and its use is provided at page 24, line 24 onwards of the specification accompanying international application no. PCT/NZ2015/05034 [publ. no. WO 2015/147657 A1].

### BRIEF DESCRIPTION OF DRAWINGS

FIG. 1. Exploded view of the filtration membrane assembly (Sterlitech Corp.) used in the flux testing of samples of sheets of filtration membrane.

FIG. 2. A comparison of the spectra (3800 cm⁻¹ to 525 cm⁻¹) recorded for the untreated microporous poly(ethylene) (TARGRAY™ wet process polyethylene separators, item no. SW320H (Targray, Kirkland QC, Canada)) (PE virgin) and the triblock copolymer (PLURONIC™ P-123; lot #MKCC2305, Sigma-Aldrich) (P123) used in the preparation of the samples, and the top (Etop) and back (Eback) side of each of the samples designated 040918Wiv, 340918Wv and 040918Wvi.

FIG. 3. A comparison of the spectra from FIG. 2 expanded over the ‘fingerprint region’ (1800 cm⁻¹ to 600 cm⁻¹).

FIG. 4. A comparison of the spectra (3800 cm⁻¹ to 525 cm⁻¹) recorded for regions of the sample designated 40918Wvi with (Ctop and Cback) and without (Etop and Eback) exposure to the feed stream.

FIG. 5. Scanning electron micrographs of the top (Etop) side of the sample designated 040918Wiv at magnifications of 250,000× (A), 35,000× (B) and 10,000× (C).

FIG. 6. Scanning electron micrographs of two regions of the top (Etop) side the sample designated 040918Wiv at a magnification of 100,000×.

FIG. 7. Comparison of the flux (LMH) maintained for samples of filtration membrane (1804.19Wi and 230419Wii (▪); 180419Wii and 230419Wiii (●)) prepared with (solid line) and without (broken line) a crosslinking agent (DVB).

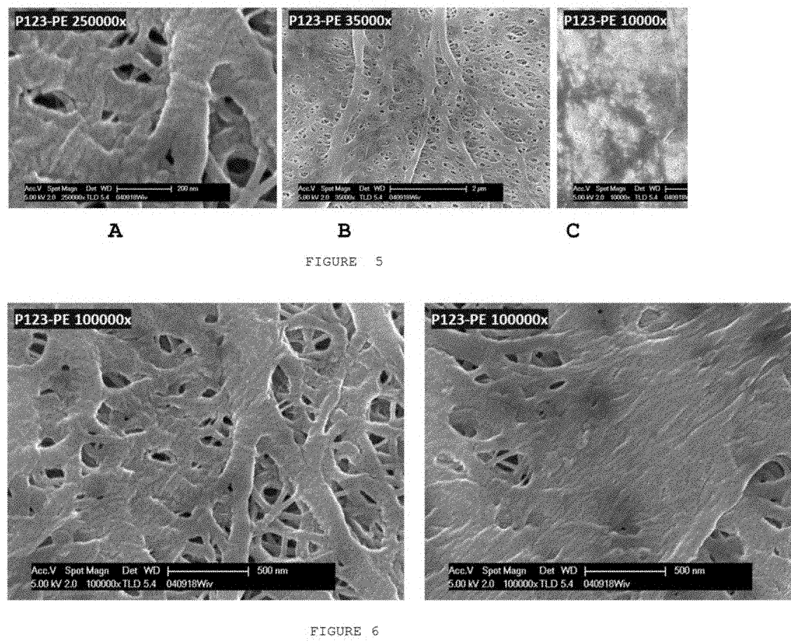

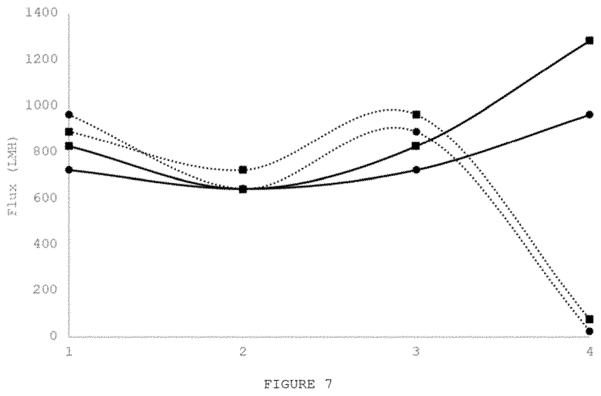

FIG. 3. Schematic representation of the prototype production line used in the preparation of the water-wettable filtration membrane according to Example C.

FIG. 9. Photograph of bottles containing samples of used caustic cleaning solution (left bottle) and permeate (right bottle) following filtration of the used caustic cleaning solution as described in Example E.

FIG. 10. Plot of flow rate (litres/minute) at each of the two inlets (solid and broken lines) of the rate versus reading (seconds) on time during filtration of the used caustic cleaning solution shown in FIG. 9 (left bottle).

FIG. 11. Plot of flow rate (litres/minute) of the permeate shown in FIG. 9 (right bottle) versus reading (seconds) on timer during filtration of used caustic cleaning solution.

FIG. 12. Photograph of bottle containing samples of less pigmented used caustic cleaning solution (left bottle) and permeate (right bottle) following filtration of the used caustic cleaning solution as described in Example E.

FIG. 13. Plot of flow rate (litres/minute) of the permeate shown in FIG. 12 (right bottle) versus reading (seconds) on timer showing filtration of the less pigmented used caustic cleaning solution.

FIG. 14. Photograph of bottles containing samples of heavily contaminated, i.e. high solids, used caustic cleaning solution (left and middle bottles) and permeate (right bottle) following filtration of the used caustic cleaning solution as described in Example E.

FIG. 15. Photograph of bottles containing samples of used citric acid cleaning solution (left bottle) and permeate (middle bottle) and concentrate i.e. retentate (right bottle) following filtration of the used citric acid cleaning solution.

FIG. 16. Plot of flow rate (litres/minute) of the permeate shown in FIG. 15 (middle bottle) versus reading (seconds) on time during filtration of the used citric acid cleaning solution.

FIG. 17. Appearance of a volume of 10 mL of working solution prepared according to methods 1, 2 and 3 of EXAMPLE G. ‘Working solution A’ contains a quantity of 0.15 g poly(ethenol) (PVA, 65 kDa). ‘Working solution B’ contains a quantity of 0.25 g poly(ethenol) (PVA, 65 kDa). The turbid ‘working solution C’ contains a quantity of 0.5 g poly(ethenol) (PVA, 65 kDa).

FIG. 18. Appearance of the replicate samples prepared according to method 6 of EXAMPLE G and designated 041918wi, 041918wii and 041918wiii.

FIG. 19. A comparison of the spectra (3800 cm⁻¹ to 525 cm⁻¹) recorded for the untreated microporous poly(ethylene) (TARGRAY™ wet process polyethylene separators, item no. SW320H (Targray, Kirkland QC, Canada)) (PE virgin), the triblock copolymer (PLURONIC™ P-123; lot #MKCC2305, Sigma-Aldrich) (P123) and poly(ethenol) (PVA, 65 kDa) (PVA65) used in the preparation of the samples, and the centre (−C) and edge (−E) of each of the samples designated 310818wi, 030918wii and 030918wi.

FIG. 20. A comparison of the spectra expanded over the ‘fingerprint region’ (1800 cm⁻¹ to 600 cm⁻¹) recorded for the untreated microporous poly(ethylene) (TARGRAY™ wet process polyethylene separators, item no. SW320H (Targray, Kirkland QC, Canada)) (PE virgin), the triblock copolymer (PLURONIC™ P-123; lot #MKCC2305, Sigma-Aldrich) (P123) and poly(ethenol) (PVA, 65 kDa) (PVA65) used in the preparation of the samples, and the centre (−C) and edge (−E) of each of the samples designated 310818wi, 030918wii and 030918wi.

FIG. 21. Photograph of vials containing partially crosslinked poly(ethenol) (xPVA) prepared according to method 2 of EXAMPLE H. From left to right: Vial 1, Vial 2, Vial 3 and Vial 4.

### DESCRIPTION

Filtration membranes are used in a range of industrial processes, including food processing, to recover or remove water from a feed stream. In one application the objective may be to separate the water from contaminating particulates. In another application the objective may be to concentrate high value solutes. In either application efficiency is increased by contacting the feed stream with a large surface area of the filter membrane. To this end the filtration membrane will often be assembled into a spiral wound filter element, which is then installed in the industrial plant. Such spiral wound membrane assemblies—or “filter elements”—are supplied by manufacturers such as Synder Filtration (Vacaville, Calif., USA).

Further efficiencies are realised if cleaning can be performed in place without the need for removal and reinstallation of the filter element. Clean-in-place protocols use chemically aggressive solutions such as acid, alkali and hypochlorite. Alternatively, the feed streams to which the membrane is exposed may be chemically aggressive and durability under these conditions reduces the frequency with which the filter element needs to be replaced.

Microporous sheets of polyolefin, such as poly(ethylene) are available commercially from suppliers such as Celgard (Charlotte, N.C., USA) and Targray (Kirkland, Quebec, Canada). One impediment to the use of these substrates as filtration membranes in the applications alluded to above is there inherent hydrophobicity. Where the objective is to provide a semipermeable membrane for use in concentrating high value solutes the required rejection properties may also be lacking.

It has now been determined that the grafting of a microporous sheet of poly(ethylene) with a preformed polymer such as the poloxamer supplied under the trade name PLURONIC-P123 provides a filtration membrane that is readily wetted with water and provides high flux rates at relatively low pressures (5 bar). The filtration membranes so produced have also been demonstrated to have the desired durability when exposed to chemically aggressive liquids. The retention of these desirable properties—attributable to the graft—is enhanced by the inclusion of a crosslinking agent in the working solution used in the method of preparation. Without wishing to be bound by theory low molecular weight crosslinking agents are favoured so as not to disrupt the favourable rejection properties also demonstrated for the membranes.

The method of preparing the filtration membrane is readily adaptable to a continuous production process. In accordance with the methods described, working solutions of the following composition are used to impregnate the microporous substrate before it is irradiated with ultraviolet light at a wavelength in the range 250 nm to 360 nm, wavelengths at or toward the lower end of this range (250 nm) being preferred.

Working Solution:
3 to 5% (w/v) poloxamer
0.5 to 1% (w/v) photoinitiator
0 to 0.5% (w/v) crosslinking agent
30 to 50% (v/v) in alcohol or acetone in water (‘solvent’)

The preferred poloxamer for use in the working solution is that supplied under the trade name PLURONIC P-123. The preferred photoinitiator for use in the working solution is benzophenone. The preferred crosslinking agent for use in the working solution is divinylbenzene.

The working solution may additionally comprise a second preformed polymer dispersed in the solvent. A suitable second preformed polymer is poly(ethanol). The inclusion of a second preformed polymer may be used to refine the properties (durability, flux or selectivity) of the filtration membrane.

### Example A—Preparation of Filtration Membrane (Laboratory Method, Poloxamer Only)

A volume of 5 ml, of a solution in water of 10% (w/v) triblock copolymer (PLURONIC™ P-123; lot #MKCC2305, Sigma-Aldrich) was mixed with an equal volume of deionised water. A quantity of 0.1 g of the photoinitiator benzophenone (diphenylmethanone; Ph₂O) was dissolved in a separate volume of 5 mL of ethanol before being added to the diluted solution of the triblock copolymer. The working solution was stored in the dark until use.

Samples (13.5×18.5 cm) were cut from a sheet of microporous poly(ethylene) (TARGRAY™ wet process polyethylene separators, item no. SW320H (Targray, Kirkland QC, Canada)) and each sample coated with a volume of 5 mL of the working solution. The coated samples were then irradiated with ultraviolet (UV) light in the range 250 to 360 nm for a period of time of two minutes before rinsing with water and air-drying on top of a warm oven.

The four replicate samples prepared according to this method were designated 040918Wiv, 040918Wv, 040918Wvi and 151018Wi. A small piece of the sample designated 040418Wiv was excised from the edge of the sample and submitted to scanning electronic microscopy (SEM).

Each of the samples was readily wetted with water, being observed to become uniformly translucent when contacted with this solvent.

### Durability, Flux and Protein Rejection

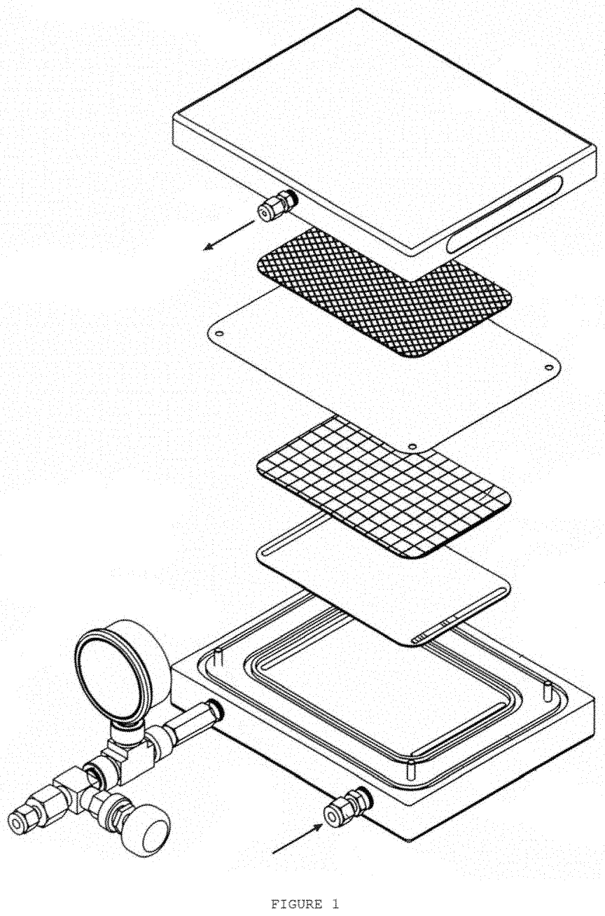

A filtration membrane assembly (Sterlitech) as illustrated in FIG. 1 was used to determine flux (LMH) for each of the samples designated 040916Wiv, 040918Wv and 040918Wvi. Samples were individually mounted in the filtration membrane assembly and the flux determined at 0 and 5 bar. The time to collect a predetermined volume of permeate at the specified pressure and temperature was recorded and the flux (J) was calculated according to the following equation:

$$J = \frac{V}{t \times A}$$

where V was the volume of permeate (L), t was the time (h) for the collection of V and A was area of the sample (m²) exposed to the feed stream (water or skim milk). The results are summarised in Table 1.

TABLE 1
Fluxes (LMH) determined at 0 and 5 bar with water as the feed stream at
the temperatures (° C.) specified.

| | Temperature | Flux | |
|---|---|---|---|
| Sample | 0 bar/5 bar | 0 bar | 5 bar |
| 040918Wiv | 9/9 | 10 | 367 |
| 040918Wv | 15/11 | 33 | 476 |
| 040918Wvi | 10/9 | 32 | 428 |

To assess durability fluxes were also determined after repeated clean-in-place (CIP) protocols. The CIP protocol was based on that employed in a commercial processing operation for reverse osmosis (RO) membranes (Anon (2014)) and is summarised in Table 2.

TABLE 2
Clean-in-place (CIP) protocol adaptad from Anon (2014). The ‘alkali’
was 2% (w/v) sodium hydroxide (NaOH). The ‘acid’ was 1.9% (w/v)
nitric acid (H₂NO₃) and 0.6 (w/v) phosphoric acid (H₃PO₄).

| Step | Feed stream | Time (min) | Temperature (° C.) |
|---|---|---|---|
| 1 | water | 5 | Ambient |
| 2 | water | 5 | 35 |
| 3 | alkali | 5 | 35 |
| 4 | water | 5 | 35 |
| 5 | acid | 10 | 35 |
| 6 | water | 5 | Ambient |
| 7 | hypochlorite | 5 | 35 |
| 8 | water | 5 | Ambient |

For each sample, a number of CIP protocols were repeated alternating with the use of water or skim milk as the feed stream. The fluxes and percentage protein rejection (with skim milk as the feed stream) determined for the samples designated 040918Wv and 040918Wvi are provided in Table 3. Total protein concentrations in permeate were calculated on the basis of HPLC analysis with UV absorbance monitoring.

TABLE 3
Fluxes (LMH) and protein rejection determined at 0 and
5 bar with water or skim milk as the feed stream at the
temperatures (° C.) specified. Determinations were made for
each of the samples following repeated clean-in-place (CIP) protocols.

| | Feed | CIP | Temperature (° C.) | Flux (LMH) | | Protein |
|---|---|---|---|---|---|---|
| Sample | stream | protocols | 0 bar/5 bar | 0 bar | 5 bar | rejection (%) |
| 040918Wiv | water | 0 | 9/9 | 10 | 367 | |
| 040918Wv | water | 0 | 15/11 | 33 | 476 | |
| 040918Wv | water | 1 | 10/10 | 6 | 139 | |
| 040918Wv | water | 2 | —/12 | — | 195 | |
| 040918Wv | water | 3 | —/11 | — | 171 | |
| 040918Wv | water | 6 | —/10 | — | 476 | |
| 040918Wv | water | 10 | 11/10 | 46 | 494 | |
| 040918Wv | milk | 3 | —/11 | — | 21 | |
| 040918Wv | water | 6 | —/10 | — | 476 | |
| 040918Wv | water | 10 | 11/10 | 46 | 494 | |
| 040918Wv | milk | 10 | 11/12 | 4 | 21 | 99.4 |
| 040918Wvi | water | 0 | 10/9 | 32 | 428 | |
| 040918Wvi | water | 1 | 19/10 | 43 | 642 | |
| 040918Wvi | water | 2 | 13/12 | 40 | 714 | |
| 040918Wvi | water | 3 | 10/10 | 38 | 644 | |
| 040918Wvi | milk | 3 | 9/11 | 3 | 24 | |
| 040918Wvi | water | 4 | —/9 | — | 56 (dry) | |
| 040918Wvi | milk | 4 | —/10 | — | 9 | 99.71 |
| 040918Wvi | water | 5 | 10/9 | 38 | 234 | |
| 040918Wvi | water | 7 | 9/9 | 60 | 803 | |
| 040918Wvi | water | 10 | 11/10 | 64 | 188 | |
| 040918Wvi | milk | 10 | —/12 | — | 9 | 99.76 |

The durability of the filtration membranes was further evaluated by contacting the sample designated 151018Wi with 2% (w/v) sodium hydroxide (NaOH) for 7 days.

The fluxes and percentage protein rejection (with skim milk as the feed stream) determined for these samples are provided in Table 4.

TABLE 4
Fluxes (LMH) and protein reledtion determined at 0 and 5 bar with
water or skim milk as the feed stream at the temperatures (° C.)
specified. Determinations were made for the samples following
exposure to 2% (w/v) sodium hydrozide (NaOH) for 7 days.

| | Feed | Temperature (° C.) | Flux (LMH) | | Protein |
|---|---|---|---|---|---|
| Sample | stream | 0 bar/5 bar | 0 bar | 5 bar | rejection (%) |
| 151016Wi | water | 9/9 | 54 | 257 | |
| 151016Wi | milk | 10/10 | — | 8 | 99.65 |

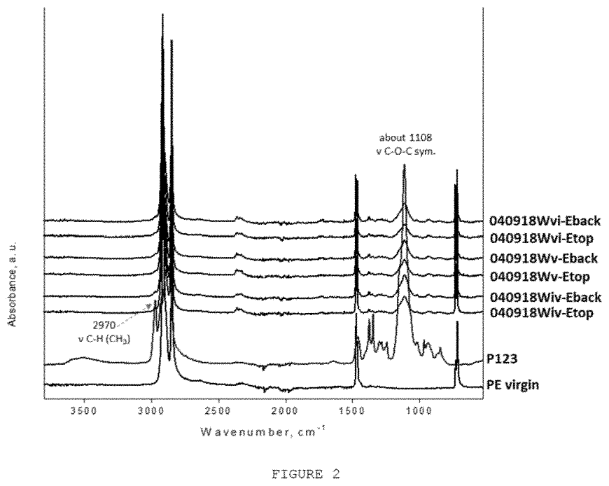

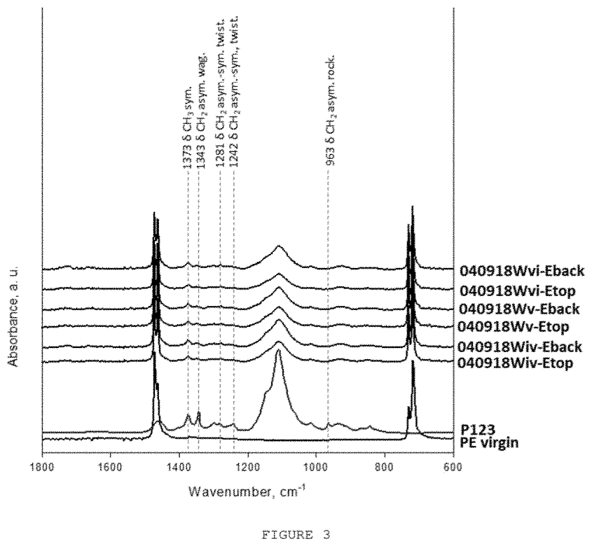

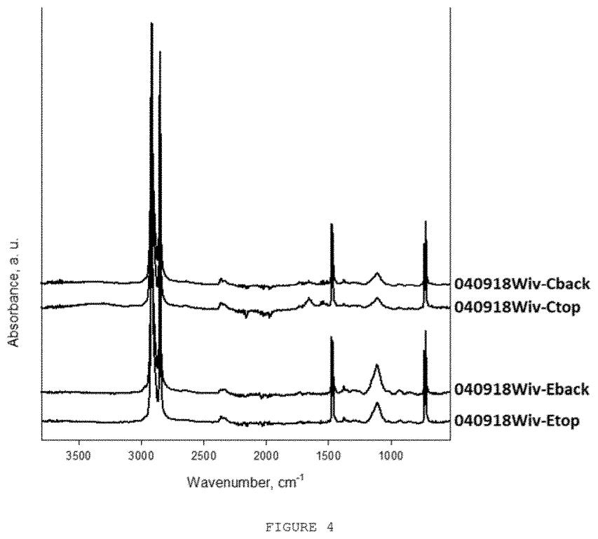

Fourier Transform Infrared (FTIR) Spectroscopy Spectra were recorded for each of the samples designated 040918Wiv, 040918Wv and 040913Wvi using a Thermo Electron Nicolet 8700 FTIR spectrometer equipped with a single bounce ATR and diamond crystal. Thirty-two scans at a resolution of 4 cm⁻¹ were averaged for each sample. A comparison of the spectra (3800 cm⁻¹ to 525 cm⁻¹) recorded for: (i) the untreated microporous poly(ethylene) (TARGRAY™ wet process polyethylene separators, item no. SW320H (Targray, Kirkland QC, Canada)) (‘PE virgin’); (ii) the triblock copolymer (PLURONIC™ P-123; lot #MKCC2305, Sigma-Aldrich) used in the preparation of the samples (‘P123’); and (iii) the top (Etop) and back (Eback) sides of each of the samples designated 040918Wiv, 040918Wv and 040918Wvi is provided in FIG. 2.

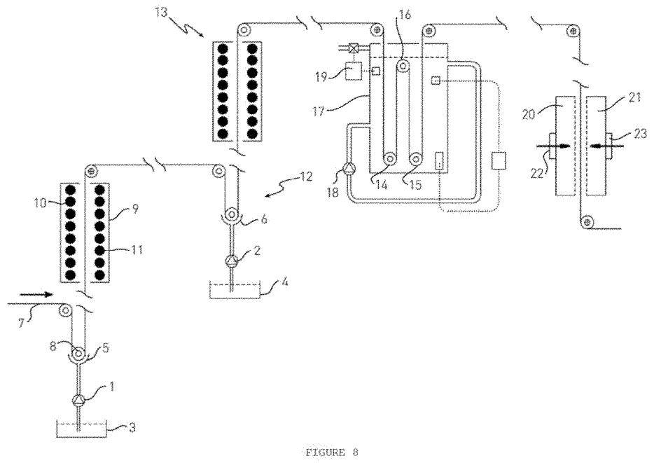

Signals corresponding to the symmetrical stretch mode of C—O—C fragments (1108 cm⁻¹) and the C—H stretch mode of CH₃ (2970 cm⁻¹) present in the spectrum of the triblock copolymer (PLURONIC™ P-123) were also present in the spectra recorded for each of the samples. Many signals characteristic of the triblock copolymer (PLURONIC™ P-123) were also observed at low intensity in the ‘fingerprint’ region of the spectra provided in FIG. 31. Signals characteristic of the triblock copolymer (PLURONIC™ P-123) were retained in spectra recorded for regions of the sample designated 040918Wiv following exposure to the feed stream (water) as shown in FIG. 4.

SEM

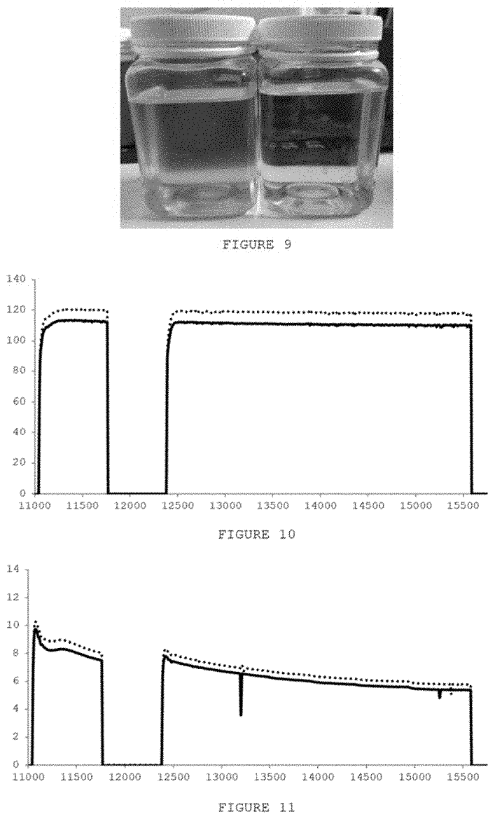

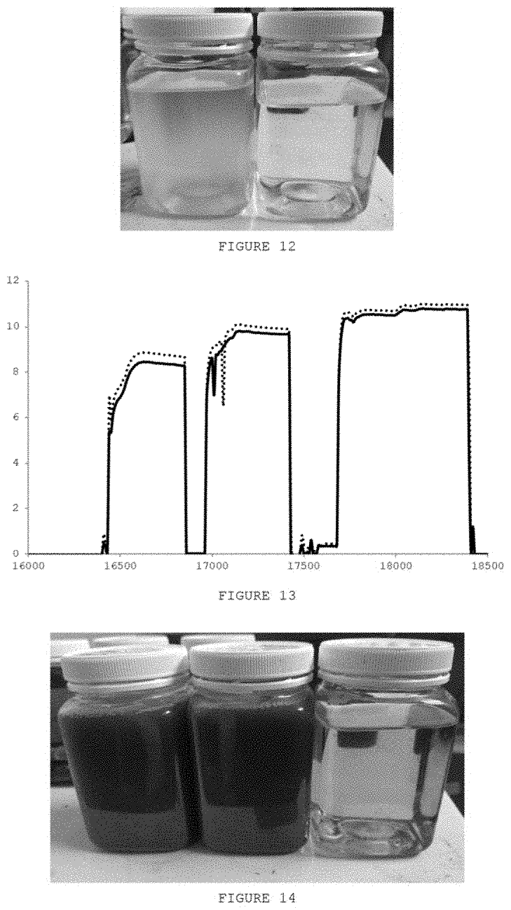

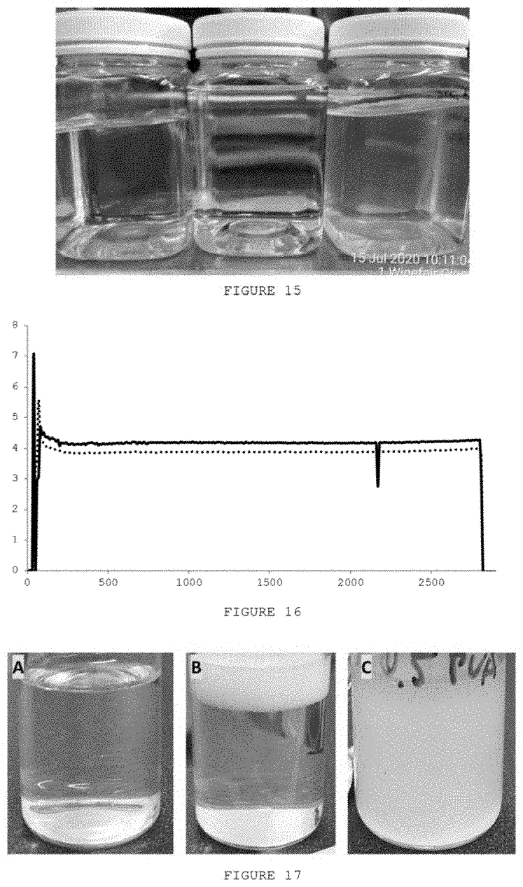

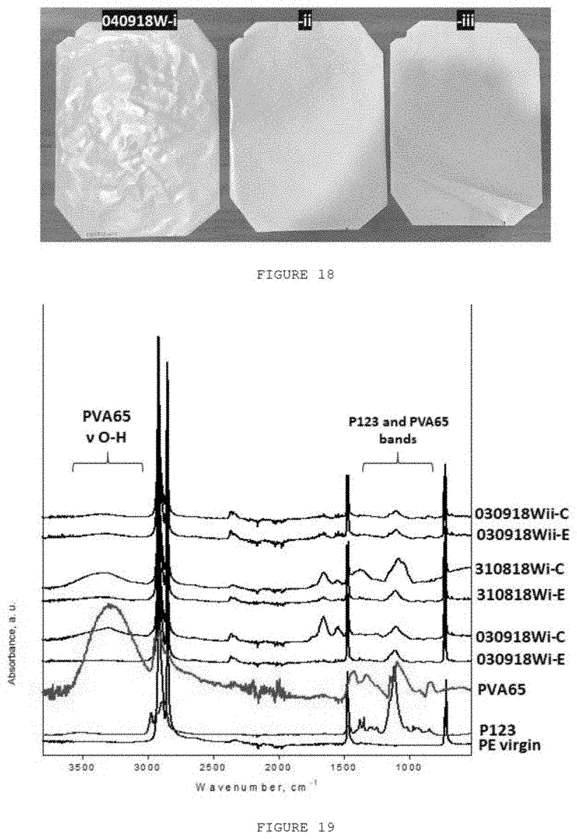

Scanning electron micrographs of the small piece excised from the edge of the sample designated 040918Wiv are provided in FIG. 5 and FIG. 6. The fibres of poly(ethylene) of the microporous sheet appear to be coated.

The observations from FTIR spectroscopy and SEM appeared to demonstrate the grafting of the poloxamer to the polyolefin matrix of the microporous sheet. The conversion of the inherently hydrophobic microporous sheet of polyolefin to a water-wettable permeable membrane is attributed to this grafting.

### Example B—Preparation of Filtration Membrane (Laboratory Method)

A volume of 10 mL of a solution in water of 10% (w/v) triblock copolymer (PLURONIC™ P-123; lot #MKCC2305, Sigma-Aldrich) was mixed with an equal volume of deionised water. Quantities of 0.2 g of the photoinitiator benzophenone (diphenylmethanone; Ph₂O) and 0 or 0.1 g of the crosslinking agent divinylbenzene (DVB) were dissolved in separate volumes of 10 mL of ethanol (methylated spirits) before being added to a volume of 10 mL of the diluted solution of the triblock copolymer. These working solutions—excluding or including the crosslinking agent. DVB—were stored in the dark until use.

Samples (13.5×18.5 cm) were cut from a sheet of microporous poly(ethylene) (TARGRAY™ wet process polyethylene separators, item no. SW320H (Targray, Kirkland QC, Canada)) and each sample coated with a volume of one of the working solutions. The coated samples were then irradiated with ultraviolet (UV) light in the range 250 to 360 nm for a period of time of two minutes before rinsing with water and air-drying in open air.

The three replicate samples prepared according to this method using the working solution excluding DVB were designated 110419Wi, 180419Wi and 180419Wiii. The three replicate samples prepared according to this method with the working solution including DVB were designated 230419Wi, 230415Wii and 230419Wiii. Each of the samples was readily wetted with water, being observed to become uniformly translucent when contacted with this solvent.

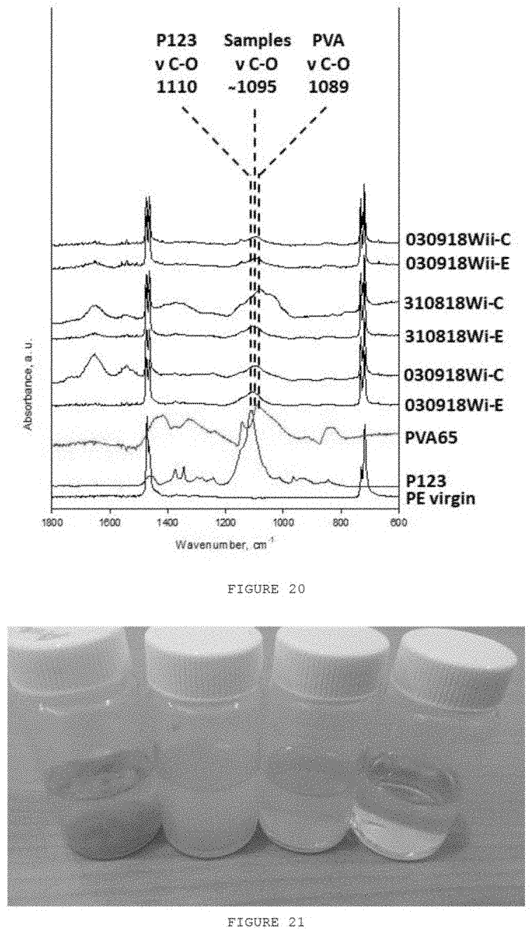

The water flux was determined for each of the samples with deionised water as the feed stream (DI1). The samples were then completely dried before again determining the water flux with deionised water as the feed stream (DI2). Each of the samples were then subjected to a clean-in-place (CIF) protocol before twice more determining the water flux with deionised water as the feed stream (DI3 and DI4) and an intervening drying of the samples. Each of the samples remained readily wettable with water. The results are summarised in Table 5 and Table 6 and compared in FIG. 7.

TABLE 5
Average fluxes (LMH) determined at room temperature (22 to 24° C.)
at 0 and 5 bar with water as the feed stream (*membrane failure). No
crosslinking aqent included in the ‘working solution’.

| | | Flux | |
|---|---|---|---|
| Sample | DI# | 0 bar | 5 bar |
| 110419Wi | 1 | 61 | 964 |
| | 2 | 32 | 771 |
| | 3 | 38 | 964 |
| | 4 | 95 | 1446* |
| 180419Wi | 1 | 70 | 890 |
| | 2 | 35 | 723 |
| | 3 | 48 | 964 |
| | 4 | — | 76 |
| 180419Wii | 1 | 62 | 964 |
| | 2 | 34 | 643 |
| | 3 | 36 | 890 |
| | 4 | — | 26 |

TABLE 6
Average fluxes (LMH) determined at room temperature (22 to 24° C.)
at 0 and 5 bar with water as the feed stream. Crosslinking agent (DVB)
included in the ‘working solution’.

| | | Flux | |
|---|---|---|---|
| Sample | DI# | 0 bar | 5 bar |
| 230419Wi | 1 | 43 | 680 |
| | 2 | 15 | 321 |
| | 3 | 24 | 609 |
| | 4 | 15 | 399 |
| 230419Wii | 1 | 345 | 826 |
| | 2 | 28 | 642 |
| | 3 | 34 | 826 |
| | 4 | 17 | 1285 |
| 230419Wiii | 1 | 26 | 723 |
| | 2 | 33 | 642 |
| | 3 | 56 | 723 |
| | 4 | 26 | 964 |

### Example C—Preparation of Filtration Membrane (Prototype Method)

A volume of 0.300 mL of a solution of 10% (w/v) triblock copolymer (PLURONIC™ P-123; lot #MKCC2305, Sigma-Aldrich) in distilled water was dispensed into a reservoir protected from exposure to light. A further volume of 300 mL of distilled water was then added to provide an initial solution of 5% (w/v) triblock copolymer (PLURONIC™ P-123; lot #MKCC2305, Sigma-Aldrich) in the reservoir. A solution of 1.5% (w/v) benzophenone in ethanol (methylated spirits) was prepared separately and a volume of the crosslinking agent divinylbenzene (DVB) added to provide a final concentration of 0.75% (v/v) DVB. A volume of 400 mL of this separately prepared solution was then mixed with the solution of triblock copolymer (PLURONIC™ P-123; lot #MKCC2305, Sigma-Aldrich) in a reservoir to provide the working solution.

Referring to FIG. 8 of the accompanying drawings pages, peristaltic pumps (1,2) were used to deliver the working solution from the reservoirs (3,4) to the two hemicylindrical troughs (5,6) of a prototype production line. The reservoirs were periodically replenished with the working solution during the operation of the prototype production line.

The width of a continuous microporous sheet (7) of microporous poly(ethylene) was fed from a dispensing roll of stock into a first impregnation station comprising an idler roller (8) co-axially mounted in the first of the two hemicylindrical troughs (5). The difference between the radii of the roller (8) and trough (5) was sufficient to permit free passage of the sheet (7) around the roller and through the trough, but not so great as to promote evaporation of the working solution in the trough. The surface of the roller (8) over which the sheet (7) passes may be spiral engraved to promote passage of the working solution across the length of the surface.

The sheet (7) exiting the first impregnation station was then fed vertically into a first irradiating station comprising a slotted chamber (9) containing two opposed arrays (10,11) of ultraviolet light sources. The sheet (7) passed between the opposed arrays (10,11) so that both sides were irradiated. The rate at which the sheet (7) was fed was regulated to provide the required residence time within the slotted chamber (9).

The irradiated sheet (7) was then passed through a second impregnation station (12) and second irradiating station (13) of the same configuration as the first impregnation station and first irradiating station. Following these repeated steps, the irradiated sheet (7) was fed around a plurality of idler rollers (14,15,16) immersed in water in a washing station (17). The water in the washing station (17) was circulated by an external pump (18) and the depth of the water controlled by a combination of level transmitter and solenoid valve (19). The combination of a plurality of idler rollers (14,15,16) and depth of water ensured sufficient residence time before the water washed sheet (7) was fed into the drying station.

The drying station was a forced air dryer comprising two plenum chambers (20,21) having opposed perforated face plates between which the sheet of substrate passed. Hot air blowers (22,23) mounted in the wall of each chamber forced air through the perforated face plates. The dried sheet (7) of substrate was then rewound onto a receiving roll (not shown).

### Example D—Spiral Wound Filter Elements, Housing and Rig

Spiral-wound filter elements were manufactured using filtration membrane prepared according to the prototype method (EXAMPLE C). The filter elements were wound using type 34 diamond spacers. Two spiral-wound filter elements were mounted in series in each of two housings mounted in an assembly (‘rig’).

### Example E—Recovery of Cleaning Solutions

A volume of 900 litres of caustic cleaning solution that had been used to sanitize wine tanks was collected and transferred in two volumes of 300 litres and 600 litres, respectively, to the reservoir of the rig and delivered via a recirculating pump to the inlet ports of the filter housings. The used caustic solution had a translucent appearance attributed to the suspension of particulates (FIG. 9, left). The solution was pumped under constant pressure from the reservoir to the rig to provide flow rates at the filter housing inlets of 110 to 120 litres per minute (FIG. 10). Permeate was collected from each of the filter housing outlets at an initial rate of around f litres per minute, declining to a near steady rate of 5.3 litres per minute over the duration of the pump run (FIG. 11). The observed decline in flux was attributed to the concentration of the retentate in the closed system (as opposed to fouling of the membrane or spacer). This attribution is supported by the near steady flow rates observed at the housing inlets.

Over an initial duration of 2.5 hours (including 20 minutes downtime during which the contents of the reservoir were replenished) a volume concentration factor (VCF) of 8.18 was achieved. This equates to the recovery of 88% of the caustic cleaning solution.

Replenishing the contents of the reservoir with a further volume of 600 litres of caustic cleaning solution that had been used to sanitize wine tanks, but containing less pigments (FIG. 12, left), and repeating the foregoing increased the volume concentration factor to 15. Increases in the permeate flux rates were observed with this second feed stock (FIG. 13) supporting minimal fouling of the membranes and spacers having occurred during the initial run.

Replenishing the contents of the reservoir with a further volume of 500 litres of caustic cleaning solution that had been used to sanitize wine tanks that were heavily contaminated with solids (FIG. 14, left), a final volume concentration factor of 20 was achieved, albeit with a reduced permeate flux of around 3 litres per minute. A volume concentration factor of 20 equates to a recovery of 95% (w/w) of the caustic cleaning solution.

Samples of the cumulative volumes (900 L, 1,500 L and 2,000 L) of recovered caustic cleaning solution were titrated to pH 7 using 0.1 N sulphuric acid (H₂SO₄) and an auto-titrator.

TABLE 7
Recovery of caustic cleaning solution from a series of
cleaning operations. (*Dilution of feed stream during processing.)

| Cumulative volume | pH (initial) | | | Titration volume (mL) | | | Permeate |
|---|---|---|---|---|---|---|---|
| (L) of used | feed | | | feed | | | recovery |
| cleaning solution | stream | retentate | permeate | stream | retentate | permeate | (% (v/v)) |
| 900 | N/A | N/A | N/A | — | 8.13 | 8.28 | 98.2 |
| 1,500 | 11.93 | 11.94 | 11.98 | 3.09 | 3.09 | 3.12 | 99.1 |
| 2,000 | 10.52 | — | 11.96 | 0.67* | — | 3.02 | 97.7 |

To confirm the tolerance of the membrane to multiple chemistries and its utility in the recovery and reuse of the cleaning solutions typically used in beverage and food processing, a volume of citric acid cleaning solution that had been used in the cleaning of a wine tank was collected (FIG. 15, left). The volume was transferred to the cleaned reservoir and delivered via the pump at a similar flow rate to the filter housing inlets. A permeate flow rate averaging around 4 litres per minute for the duration of the run was obtained (FIG. 16). Greater than 95% (w/w) of the citric acid cleaning solution was recovered.

### Example F—Reuse of Cleaning Solutions

Recovered cleaning solutions were used to sanitize wine tanks and the efficacy of these procedures evaluated. The cleaning solutions were repeatedly recovered and reused to confirm the commercial viability of the procedures. In addition to the evaluation of the efficacy of the sanitization operations the content of the recovered and reused cleaning solutions was determined by titration as before (Tables 8 and 9).

TABLE 8
Recovery and reuse of caustic cleaning solution.

| Recovery | pH (initial) | | Titration volume (mL) | | % |
|---|---|---|---|---|---|
| (reuse) | feed stream | permeate | feed stream | permeate | recovery |
| First | 12.42 | 12.34 | 14.02 | 14.28 | 102 |
| Second | 12.11 | 12.43 | 4.81 | error | n.d. |
| (first) | | | | | |
| Third | 11.94 | 12.13 | 5.17 | 5.13 | 99.2 |
| (second) | | | | | |
| Fourth | 12.33 | 13.34 | 4.61 | 4.61 | 100 |
| (third | | | | | |
| Fifth | 12.13 | 12.09 | 4.13 | 3.98 | 96.5 |
| (fourth) | | | | | |

TABLE 9
Recovery and reuse of citric acid cleaning solution.

| Recovery | Titration volume (ML) | | | |
|---|---|---|---|---|
| (reuse) | feed stream | retentate | permeate | % recovery |
| First | 5.71 | 5.65 | 5.62 | 98.4 |
| Second | 5.01 | 5.12 | 5.08 | 99.2 |
| (first) | | | | |

### Example G—Preparation of Filtration Membrane (Laboratory Method, Blend of Polymers)

### Method 1

A volume of 5 mL of a solution in water of 10% (w/vi triblock copolymer (PLURONIC™ P-123; lot #MKCC2305, Sigma-Aldrich) was mixed with an equal volume of a solution in water of 0.25 g of poly(ethenol) (PVA, 65 kDa). A quantity of 0.1 g of the photoinitiator benzophenone (diphenylmethanone; Ph₂O) was dissolved in a separate volume of 5 mL, of ethanol before being added to the solution of the triblock copolymer and poly(ethenol) (PVA, 65 kDa). The solution (‘working solution A’) was stored in the dark until use.

### Method 2

A volume of 5 mL of a solution in water of 10% (w/v) triblock copolymer (PLURONIC™ P-123; lot #MKCC2305, Sigma-Aldrich) was mixed with a volume of 3 mL of a solution in water of 0.15 g of poly(ethenol) (PVA, 65 kDa). A quantity of 0.1 g of the photoinitiator benzophenone (diphenylmethanone; Ph₂O) was dissolved in a separate volume of 5 mL of ethanol before being added to the solution of the triblock copolymer and poly(ethenol) (PVA, 65 kDa). The solution (‘working solution B’) was stored in the dark until use.

### Method 3

A quantity of 0.5 g triblock copolymer (PLURONIC™ P-123; lot #MKCC2305, Sigma-Aldrich) was dissolved in a volume of 10 mL, of a solution in water of 0.5 g of poly(ethenol) (PVA, 65 kDa) with the addition of a volume of 5 mL ethanol and at a temperature of 55° C. A quantity of 0.1 g of the photoinitiator benzophenone (diphenylmethanone; Ph₂O) was dissolved in the solution of the triblock copolymer and poly(ethenol) (PVA, 65 kDa) and this turbid, but homogenous solution (‘working solution C’) was stored in the dark until use.

The appearance of each of the working solutions (A, B and C) prepared according to method 1, 2 and 3 is presented in FIG. 17.

### Method 4

Samples (13.5×18.5 cm) were cut from a microporous sheet of poly(ethylene) (TARGRAY™ wet process polyethylene separators, item no. SW320H (Targray, Kirkland QC, Canada)) and each sample coated with a volume of 5 mL of the working solution. The coated samples were then irradiated with ultraviolet (UV) light in the range 250 to 360 nm for a period of time of two minutes before rinsing with water and air-drying on top of a warm oven. Working solution A was used for the preparation of the sample designated 310818wi, working solution B was used for the preparation of the sample designated 030918wii, working solution C was used for the preparation of the sample designated 030918wi.

Each of the samples prepared according to method 4 was highly hydrophilic and readily wetted with water.

### Method 5

A quantity of 0.15 g of poly(ethenol) (PVA, 146 to 186 kDa) (PVA180) was dissolved with heating and stirring in a volume of 10 mL of water. A quantity of 0.5 g of triblock copolymer (PLURONIC™ P-123; lot #MKCC2305, Sigma-Aldrich) was then added to the volume and dissolved. A quantity of 0.1 q of the photoinitiator benzophenone (diphenylmethanone; Ph₂O) was dissolved in a separate volume of 5 mL of ethanol before being added to the volume of the triblock copolymer and poly(ethenol) (PVA, 146 to 186 kDa) (PVA180). The solution (‘working solution D’) was stored in the dark until use.

### Method 6

A sample (13.5×18.5 cm) was cut from a microporous sheet of poly(ethylene) (TARGRAY™ wet process polyethylene separators, item no. SW320H (Targray, Kirkland QC, Canada)) and coated with a volume of 5 mL of working solution D. The coated sample was then irradiated with ultraviolet (UV) light in the range 250 to 360 nm for a period of time of two minutes before rinsing with water and air-drying on top of a warm oven.

Three replicate samples were prepared according to method 5 and designated 041918wi, 041918wii and 041918wiii. The appearance of these samples is provided in Figure S.

The flux (LMH) was determined for each of the samples designated 310818wi, 039818wii and 030918wi. A summary of the composition of the working solution used to prepare each sample of membrane and the fluxes determined are presented in Table 10.

TABLE 10
Summary of the composition (g/10 mL) of each
working solution used to prepare each sample of membrane
(310818wi, 030918wii, 030918wi and 040918wi) and the fluxes
(LMB) determined at 0 and 5 bar with water as the feed stream

| | PLURONIC ™ | Benzo- | | | Flux | |
|---|---|---|---|---|---|---|
| Sample | P-123 | phenone | PVA65 | PVA180 | 0 bar | 5 bar |
| 030918wi | 0.5 | 0.1 | 0.15 | — | 26 | 340 |
| 310818wi | 0.5 | 0.1 | 0.25 | — | 22 | 312 |
| 030918wii | 0.5 | 0.1 | 0.5 | — | 11 | 189 |
| 040918wi | 0.5 | 0.1 | — | 0.15 | 10 | 361 |

Spectra were recorded for each of the samples designated 310818wi, 030918wii and 030918wi, the untreated microporous poly(ethylene) (TARGRAY™ wet process polyethylene separators, item no. SW320H (Targray, Kirkland QC, Canada)), and the triblock copolymer (PLURONIC™ P-123; lot #MKCC2305, Sigma-Aldrich) and poly(ethenol) (PVA, 65 kDa) used in the preparation of the samples. Spectra were also recorded for the centre (−C) and edge (−E) of each of the samples designated 310818wi, 030918wii and 030918wi. A comparison of the recorded spectra is provided in FIG. 19. A comparison of the same spectra over the ‘fingerprint’ region (1800 cm⁻¹ to 600 cm⁻¹) is provided in FIG. 20. (The edge of each sample was not exposed to the feed stream (water) during the flux testing.)

### Example H—Preparation of Composite Membranes

### Method 1

A series of preliminary experiments were performed to evaluate methods of preparing a film of cross linked poly(ethenol) (xPVA) on a surface. A solution of the radical initiator sodium persulfate (SPS) was prepared by adding a quantity of 0.2 g of SPS to a volume consisting of 10 mL deionised water and 10 mL acetone. The solution of radical initiator was applied onto the surface of each of three glass plates (Plate 1, Plate 2 and Plate 3). Plate 2 and Plate 3 were transferred to an oven and dried at a temperature of 60° C. until all solvent had evaporated to leave a thin layer of the initiator deposited on the surface. Solutions of poly(ethenol) (PVA) were prepared at a concentration of 1% (w/v) in either dimethyl sulfoxide (DMSO) or deionised water. The solution of poly(ethenol) (PVA) in DMSO was sprayed onto the wet surface of Plate 1 and the plate then transferred to an oven and dried at a temperature of 60° C. The solution of poly(ethenol)(PVA) in DMSO was also sprayed onto the dry surface of Plate 2 and the plate then transferred to an oven and dried at a temperature of 60° C. The solution of poly(ethenol) in deionised water was sprayed onto the dry surface of Plate 3 and the plate then transferred to an oven and dried at a temperature of 60° C. The desired film of cross-linked poly(ethenol) was not formed on Plate 1. The failure attributed to the presence of acetone causing the polymer to crash out of solution. The film formed on Plate 2 was too frangible to be useful as a rejection layer of a composite membrane. A clear, peelable film formed on the surface of Plate 3. The film was not brittle, and this method of preparation was adopted for use in the preparation of the composite membrane.

### Method 2

A series of preliminary experiments were performed to evaluate methods of preparing a film of partially cross-linked poly(ethenol) (xPVA) and thereby control the properties of the rejection layer of the composite membrane. Volumes of 10 mL of a 1% (w/v) solution of poly(ethenol) (PVA) in deionised water containing a quantity of 0.1 g of SPS were dispensed into each four vials (Vial 1, Vial 2, Vial 3 and Vial 4). The solution in each vial was heated to a temperature of 75° C. and maintained at this temperature with stirring until the following observations were made (and the vials then cooled):
A yellow solid crashed out of solution (Vial 1; 3 to 4 minutes)
A cloudy white solution with some precipitation formed (Vial 2, around 3 minutes)
A cloudy white solution formed (Vial 3; 1.5 to 2 minutes)
A cloudy solution started to form (Vial 4; 10 to 20 seconds)

The observations are also presented in FIG. 21. The method of preparing partially cross-linked poly(ethenol) according to that formed in Vial 3 was adapted for use in the preparation of the membrane.

### Method 3

In a proposed alternative method, a volume of 20 mL of the solution of the radical initiator sodium persulfate (SPS) is prepared according to Method 1. A volume of the solution of partially cross-linked poly(ethenol) (xPVA) is prepared according to Method 2 (Vial 3). The solution of the radical initiator is applied to one surface of a hydrophilicitized sheet of microporous poly(ethylene) prepared according to EXAMPLE A. The sheet is then placed on a glass plate and transferred to an oven and dried at a temperature of 60° C. The solution of partially cross-linked poly(ethenol) is applied to the same surface of the dried sheet and the sheet then returned to the oven and dried at 60° C. The dried membrane is then washed with cool water and air dried before evaluation for flux, total solids and salts rejection with different feed streams (water and milk).

### Method 4

A radical initiator containing volume of 8% (w/v) poly(ethenol) (PVA) was prepared by dissolving a quantity of 0.2 g of the radical initiator sodium persulfate (SPS) in a volume of 6.5 mL of distilled water and then adding the solution to a volume of 13.5 mL of 12% (w/v) poly(ethenol)(PVA). The volume of 6% (w/v) poly(ethenol) (PVA) was stirred with heating to 75° C. and monitored until the solution became a pale-yellow colour. The pale-yellow solution was cooled and then applied to a hydrophilicitized sheet of microporous poly(ethylene) prepared according to EXAMPLE A. The sheet was irradiated with ultraviolet (UV) light (250 nm) for 2 minutes before drying on a glass plate in an oven at 60° C.

### Method 5

A radical initiator containing volume of 5% (w/v) poly(ethenol)(PVA) was prepared by dissolving a quantity of 0.2 g of the radical initiator sodium persulfate (SPS) in a volume of 11.5 mL of distilled water and then adding the solution to a volume of 8.5 mL of 12% (w/v) poly(ethenol)(PVA). The volume of 5% (w/v) poly(ethenol) (PVA) was stirred with heating to 15° C. and monitored until the solution became a pale-yellow colour. The pale-yellow solution was cooled and then applied to a hydrophilicitized sheet of microporous poly(ethylene) prepared according to EXAMPLE A. The sheet was irradiated with ultraviolet (UV) light (250 nm) for 2 minutes before drying on a glass plate in an oven at 60° C.

Samples of membrane prepared according to Method 4 and Method 5 were evaluated. The sample prepared according to Method 4 was also evaluated following exposure to a clean-in-place (CIP) protocol. The results of these evaluations are summarised in Table 11.

TABLE 11
Mean flux (LMH) determinmd for water as the feed stream and
protein rejection (%) and mean flux (LMH) determined for milk as
the feed stream for samples of membrane prepared according to the
specified methods. Both feed streams at a pressure of 5 bar.
(*following exposure to a clean-in-place (CIP) protocol.)

| Method used to | | | |
|---|---|---|---|
| prepare membrane | Water | Milk | Rejection |
| Method 4 | 7.8 | 3.8 | 99.91 |
| Method 4* | 11.7 | 7.8 | 39.97 |
| Method 5 | 32.2 | 11.6 | 99.92 |
| EXAMPLE A | 826 | 20.6 | 99.56 |

For the manufacture of the composite membranes on an industrial scale it is proposed to prepare a radical initiator, e.g. sodium persulfate (SPS), containing solution of 6 to 10% (w/v) poly(ethenol) (PVA) and apply this directly to a hydrophilicitized sheet of microporous polyolefin before irradiating with ultraviolet (UV) light and drying.

Although the invention has been described with reference to embodiments or examples it should be appreciated that variations and modifications may be made to these embodiments or examples without departing from the scope of the invention. Where known equivalents exist to specific elements, features or integers, such equivalents are incorporated as if specifically referred to in this specification. Variations and modifications to the embodiments or examples that include elements, features or integers disclosed in and selected from the referenced publications are within the scope of the invention unless specifically disclaimed. The advantages provided by the invention and discussed in the description may be provided in the alternative or in combination in these different embodiments of the invention.

### INDUSTRIAL APPLICABILITY

Methods of preparing membranes and their use in the recovery of aqueous solutions or water from feed streams are provided. The membranes are advantageously used where the membranes are required to be exposed to chemically aggressive feed streams such as those used in clean-in-place operations of the beverage or food processing industries.

### INCORPORATION BY REFERENCE

Where the claims, description or drawings of this specification are missing in their entirety or part, the corresponding portion of the specification accompanying the most recently filed application from which priority is claimed is to be incorporated by reference so as to complete this specification in accordance with Rules 4.18, 20.5 and 20.6 of the PCT Regulations (as in force from 1 Jul. 2015 or subsequently amended).

For the purposes of 37 C.F.R. 1.57 of the United States Code of Federal Regulations the disclosures of the following publications (as more specifically identified under the heading ‘Referenced Publications’) are incorporated by reference: Jones at al (2008) and Schmolka (1973).

### REFERENCED PUBLICATIONS

Allmer et al (1988) Surface modification of polymers. I. Vapor-phase photografting with acrylic acid Journal of Polymer Science, Part A: Polymer Chemistry, 26(8), 2099-111.
Allmer et al (1989) Surface modification of polymers. II. Grafting with glycidyl acrylates and the reactions of the grafted surfaces with amines Journal of Polymer Science: Part A: Polymer Chemistry, 27, 1641-1652.
Ang et al (1980) Photosensitized grafting of styrene, 4-vinylpyridine and methyl methacrylate to polypropylene Journal of Polymer Science: Polymer Letters Edition, 18, 471-475.
Anon (2014) DOW FILMTEC™ Membranes—Cleaning procedures for DOW FILMTEC FT30 elements Tech Fact (Form No. 609-23010-02141).
Baz et al (2011) Surface UV photografting of acrylic acid onto LDPE powder and its adhesion Shenyang Huagong Daxue Xuebao 25(2), 121-125.
Bolto et al (2009) Crosslinked poly(vinyl alcohol) membranes Progress in Polymer Science, 34, 969-981.
Cadotte (1990) Alkali resistant hyper filtration membrane U.S. Pat. No. 4,895,661.
Carter et al (2018) Controlling external versus internal pore modification of ultrafiltration membranes using surface-initiated AGET-ATRP Journal of Membrane Science, 554, 109-116.
Cheng et al (2017) Method for preparing mesoporous composite film Chinese patent application no. 201611226194 [Publ. no. CN 106731886 A].
Choi (2002) Graft polymerisation, separators, and batteries including the separators U.S. Pat. No. 6,384,100.
Choi (2004) Battery separator U.S. Pat. No. 6,680,144.
Choi (2005) Graft polymerisation, separators, and batteries including the separators U.S. Pat. No. 6,955,865.
Cratt et al (2017) Asymmetric composite membrane and a method of preparation thereof International application no. PCT/IB2016/055899 [publ. no. WO 2017/056074 A1].
Edge et al (1993) Surface modification of polyethylene by photochemical grafting with 2-hydroxyethylmethacrylate Journal of Applied Polymer Science, 47, 1075-1082.
El Kholdi et al (2004) Modification of adhesive properties of a polyethylene film by photografting Journal of Applied Polymer Science 92(5), 2803-2811.
Exley (20.16) Asymmetric composite membranes and modified substrates used in their preparation International application no. PCT/IB2015/060001 [Publ. no. WO 2016/103239 A1].
Gao et al (2013) Radiation cross-linked lithium-ion battery separator with high rupture temperature and high tensile strength and manufacture method Chinese patent application no. 2013-10196439 (publ. no. CN 103421208).
Guo et al (2015) Coated microporous materials having filtration and adsorption properties and their use in fluid purification processes International application no. PCT/US2014/061326 [Publ. no. WO 2015/073161 A1].

Jaber and Gjoka (2016) Grafted ultra high molecular weight polyethylene microporous membranes international application no. PCT/US2015/061591 [publ. no. WO 2016/081729 A1].
Jones et al (2008) Compendium of polymer terminology and nomenclature IUPAC Recommendations, RSC Publishing.
Kubota and Hata (1990a) Distribution of methacrylic acid-grafted chains introduced into polyethylene film by photografting Journal of Applied Polymer Science, 41, 6359-695.
Kubota and Hata (1990b) Benzil-sensitized photografting of methacrylic acid on low-density polyethylene film Journal of Applied Polymer Science, 40, 1071-1075.
Linder et al (1983) Semipermeable composite membranes, their manufacture and use U.S. Pat. No. 4,753,725.
Liu et al (2014) With multi-scale gradient microstructure surface preparation method of a microporous membrane Chinese patent application no. 201310479920 [Publ. no. CN 103611437 A].
Ogiwara et al (1981) Photosensitized grafting on polyolefin films in vapor and liquid phases Journal of Polymer Science: Polymer Letters Edition, 19, 457-462.
Schmolka (1973) Polyoxyethylene-polyoxypropylene aqueous gels U.S. Pat. No. 3,740,421.
Shertu et al (2002) Factors affecting photo-grafting on low density polyethylene Hecheng Suzhi Ji Suliao 19(3), 5-$.
Singleton et al (1993) Polymeric sheet International Application No. PCT/GB92/01245 (publ. no. WO 93/01622).
Tazuke and Kimura (1978) Surface photografting. I. Graft polymerization of hydrophilic monomers onto various polymer films Journal of Polymer Science: Polymer Letters Edition, 16, 497-500.
Wang et al (2006) Platonic polymers and polyethersulfone blend membranes with improved fouling-resistant ability and ultrafiltration performance Journal of Membrane Science, 283, 440-447.
Xu and Yang (2000) Study on the mechanism of LDPE-AA vapor-phase photografting system Gaofenzi Xuebao (2000), 5, 594-598.
Yang and Ranby (1996a) The role of far UV radiation in the photografting process Polymer Bulletin (Berlin), 37(1), 89-96.
Yang and Ranby (1996b) Bulk surface photografting process and its applications. II. Principal factors affecting surface photografting Journal of Applied Polymer science, 63(3), 545-555.
Yang et al (2014) Preparation and application of PVDE-HFP composite polymer electrolytes in LiNi_{0.5}Co_{0.2}Mn_{0.5}O2 lithium-polymer batteries Electrochimica Acta 134, 258-265.
Yao and Ranby (1990a) Surface modification by continuous graft copolymerization. I. Photoinitiated graft copolymerization onto polyethylene tape film surface Journal of Applied Polymer Science, 40, 1647-1661.
Yao and Ranby (1990b) Surface modification by continuous graft copolymerization. III. Photoinitiated graft copolymerization onto poly(ethylene terephthalate) fiber surface Journal of Applied Polymer Science, 41, 1459-1467.
Yao and Ranby (1990c) Surface modification by continuous graft copolymerization. IV. Photoinitiated graft copolymerization onto polypropylene fiber surface Journal of Applied Polymer Science, 41, 1469-1478.
Zhang and Ranby (1991) Surface modification by continuous graft copolymerisation. II. Photoinitiated graft copolymerization onto polypropylene film surface Journal of Applied Polymer Science, 43, 621-636.

1) A water-wettable filtration membrane consisting essentially of a microporous sheet of grafted polyolefin where the graft comprises a poloxamer of the structure HO(ethylene oxide)ₘ-(propylene oxide)ₙ-(ethylene oxide)ₘH where m is in the range 15 to 25 and n is in the range 50 to 90.

2) The membrane of claim 1 where the polyolefin is poly(ethylene) or poly(propylene).

3) The membrane of claim 2 where the polyolefin is poly(ethylene).

4) The membrane of claim 3 where m is 20 and n is 70.

5) A spiral wound filter assembly comprising the membrane of claim 1.
